(19) United States
(12) Patent Application Publication
(10) Pub. No.: US 2021/0310894 A1
(43) Pub. Date: Oct. 7, 2021

(54) Leak Detection Device

(71) Applicant: Conbraco Industries, Inc., Marshville, NC (US)

(72) Inventors: Stephanie L. Cellemme, Charlotte, NC (US); Patrick W. Duncan, Marshville, NC (US)

(21) Appl. No.: 17/262,945

(22) PCT Filed: Jul. 24, 2019
(86) PCT No.: PCT/US2019/043161

§ 371 Date: Mar. 16, 2021

Related U.S. Application Data
(60) Provisional application No. 62/702,466, filed on Jul. 24, 2018.

(51) Int. Cl. G01M 3/28; G01P 13/00; G08B 21/18

(52) U.S. Cl. CPC G01M 3/28; G08B 21/182; G01P 13/002

(57) ABSTRACT

Embodiments relate to a leak detection device. In some embodiments, the leak detection device can be used within a backflow preventer to detect faulty or degraded operation of the backflow preventer or plumbing system instability. Embodiments of the leak detection device can include a movable magnetic element and a reed switch or electrical conductor element. When a leak occurs, fluid causes the movable magnetic element to move relative to the reed switch or electrical conductor element and cause the reed switch or electrical conductor element to generate a signal.

### FIELD OF THE INVENTION

Embodiments of the invention relate to a fluid flow indicator, which can be configured as a leak detection device.

### BACKGROUND OF THE INVENTION

Conventional leak detection devices may include use of complex and expensive sensors that consume a large amount of energy.

### SUMMARY OF THE INVENTION

The present invention relates to a leak detection device. In some embodiments, the leak detection device can be used with a backflow preventer (e.g., the detection device can be located within, on, or in proximity with the backflow preventer) or a component used with the backflow preventer (e.g., an overflow outlet—which can be a relief vent or an air gap drain) to detect faulty operation of the backflow preventer or other component, degraded operation of the backflow preventer or other component, the approach of a dangerous condition, system instability, etc. An example of a dangerous condition and/or system instability can be a fluctuation in pressure. In these situations, the backflow preventer would still be operating correctly but the detection would be indicative of a potential dangerous or unstable condition about to occur within the system itself (e.g., the plumbing system to which the backflow preventer is being used). Embodiments of the leak detection device can include a movable magnetic element and a reed switch or an electrical conductor element. When a leak occurs, fluid causes the movable magnetic element to move relative to the reed switch and cause the reed switch to generate a signal.

In at least one embodiment a fluid flow indicator device can include a movable magnetic element configured to be placed within a conduit, the conduit configured to be a portion of a fluid flow system designated for receiving and directing fluid when a leak occurs. The device can include at least one reed switch. In some embodiments, the movable magnetic element is configured to move relative to the at least one reed switch when fluid flows through the conduit due to the leak and imparts a force on the movable magnetic element. In some embodiments, the at least one reed switch generates a signal when the movable magnetic element is moved within a predetermined distance of the at least one reed switch.

In some embodiments, the at least one reed switch comprises a plurality of reed switches. In some embodiments, the movable magnetic element is a pin and spring assembly. Some embodiments can include a processor configured to monitor the connectivity of the at least one reed switch. In some embodiments, the conduit is a portion of a backflow preventer. In some embodiments, the conduit is attached to a portion of an overflow outlet.

In some embodiments, the at least one reed switch includes a first reed switch and a second reed switch. The first reed switch can generate a first signal when the movable magnetic element moves a distance D₁. The second reed switch can generate a second signal when the movable magnetic element moves a distance D₂, wherein is D₂>D₁.

In at least one embodiment, a fluid flow indicator device can include a housing having a housing top, a housing bottom, and a housing longitudinal axis extending from the housing top to the housing bottom. The housing can further have an opening configured to allow fluid to flow there-through. The device can include a movable magnetic element. The housing can be configured to retain the movable magnetic element and allow the movable magnetic element to move along the housing longitudinal axis.

The device can include a first reed switch and a second reed switch. In some embodiments, the first reed switch generates a first signal when the movable magnetic element moves a distance D₁, the second reed switch generates a second signal when the movable magnetic element moves a distance D₂, where D₂>D₁.

In some embodiments, the housing is configured to be placed within a conduit configured to be a portion of a fluid flow system designated for receiving and directing fluid when a leak occurs.

In some embodiments, the at least one of the first reed switch and the second reed switch is attached to the housing or the conduit. Some embodiments can include a processor configured to monitor the connectivity of the first reed switch and the second reed switch. In some embodiments, the processor is configured to request or search for a signal from the first reed switch and/or the second reed switch periodically. In some embodiments, the conduit is a portion of a backflow preventer. In some embodiments, the conduit is attached to a portion of an overflow outlet.

In some embodiments, the processor is configured to request or search for a signal from the first reed switch and/or the second reed switch continuously.

In some embodiments, the housing top has a bevel configured to funnel the fluid. In some embodiments, the housing bottom has a housing flat and a riser. In some embodiments, the housing flat has at least one housing flat aperture.

In some embodiments, the movable magnetic element includes a pin and spring assembly and the housing bottom has a riser, the riser configured for at least one of: support the pin and spring assembly so that the pin and spring assembly is oriented to be aligned with the housing longitudinal axis; secure a spring of the pin and spring assembly so as to prevent the spring from sliding in a direction perpendicular to the housing longitudinal axis; and act as a mechanical stop for the movable magnetic element.

In some embodiments, the pin and spring assembly has a pin with a magnet attached to a portion thereof, the pin configured to engage the spring so that the magnet moves in the housing longitudinal direction. In some embodiments, a resting length of the spring is such that the magnet does not come into contact with the housing top or does not allow the magnet to extend through the housing top.

In at least one embodiment, a fluid flow indicator device can include a movable magnetic element configured to be placed within a conduit. The conduit configured to be a portion of a fluid flow system designated for receiving and directing fluid when a leak occurs. The device can have at least one electrical conducting element. The movable magnetic element can be configured to move relative to the at least one electrical conducting element when fluid flows through the conduit due to the leak and imparts a force on the movable magnetic element. The at least one electrical conducting element generates a signal when the movable magnetic element is moved relative to the at least one electrical conducting element. In some embodiments, the movable magnetic element is a magnet pinwheel assembly. Some embodiments can include a processor configured to monitor the connectivity of the at least one electrical conducting element.

Further features, aspects, objects, advantages, and possible applications of the present invention will become apparent from a study of the exemplary embodiments and examples described below, in combination with the Figures, and the appended claims.

### BRIEF DESCRIPTION OF THE DRAWINGS

The above and other objects, aspects, features, advantages and possible applications of the present innovation will be more apparent from the following more particular description thereof, presented in conjunction with the following drawings. Like reference numbers used in the drawings may identify like components.

FIG. 1 shows a cross-sectional side view of an embodiment of a leak detection device.

FIG. 2 shows a top view of an embodiment of a leak detection device.

FIG. 3 shows a cross-sectional view of another embodiment of a leak detection device.

FIG. 4 shows another embodiment of a leak detection device.

FIG. 5 shows a cross-sectional view of an embodiment of a backflow preventer with an embodiment of the leak detection device.

### DETAILED DESCRIPTION OF THE INVENTION

The following description is of exemplary embodiments that are presently contemplated for carrying out the present invention. This description is not to be taken in a limiting sense, but is made merely for the purpose of describing the general principles and features of the present invention. The scope of the present invention is not limited by this description.

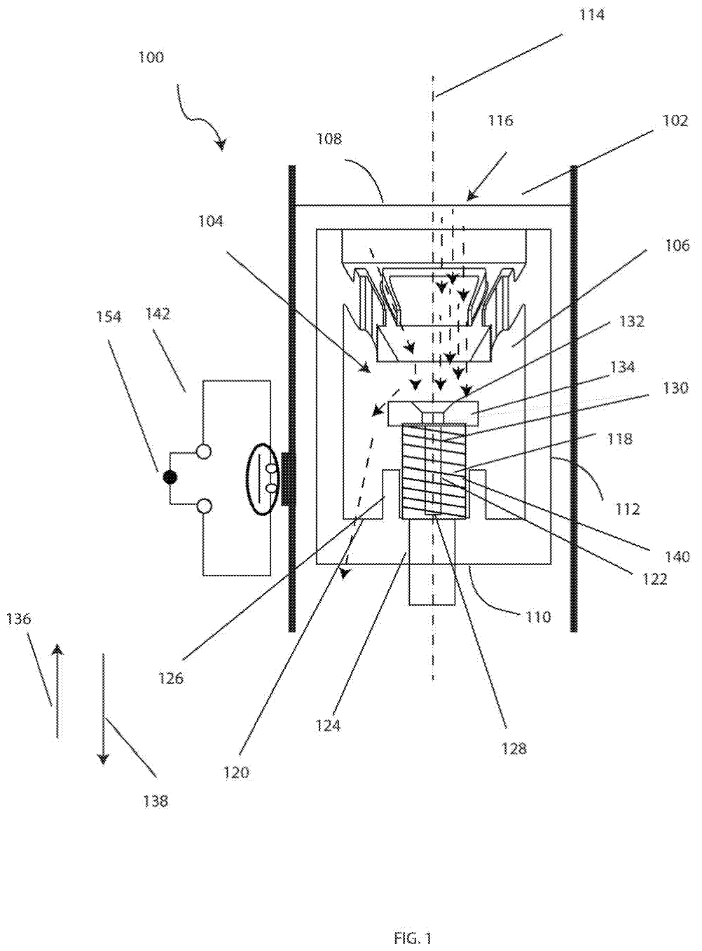

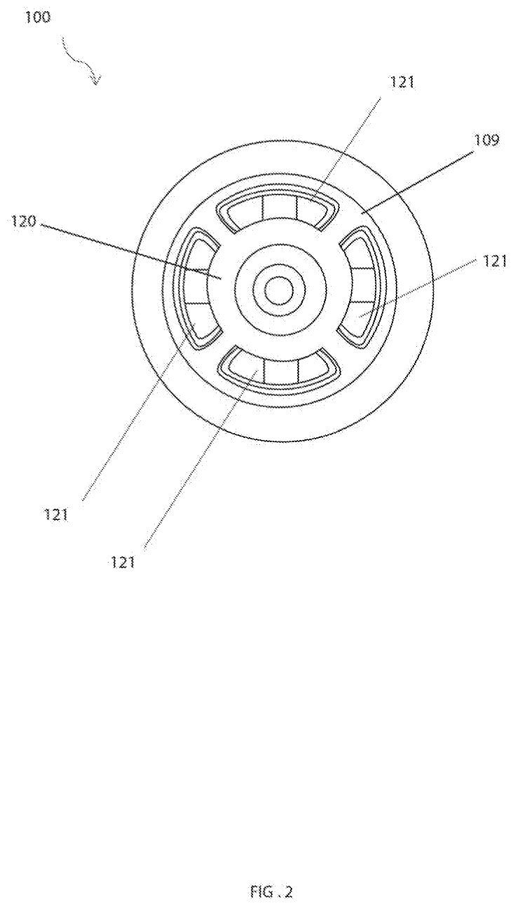

Referring to FIGS. 1-2, the leak detection device 100 can include a unit configured to detect flow of a fluid through a conduit 102. In some embodiments, the device 100 can detect the rate of fluid flow. This can be achieved via use of a movable magnetic element 104 as part of the device 100.

Embodiments of the device 100 can include a housing 106 having a housing top 108, a housing bottom 110, and housing sides 112. A housing longitudinal axis 114 can be defined as running through a center of the housing 106, extending from the housing top 108 to the housing bottom 110. The housing sides 112 can be conjoined so as to form a cylindrical shaped body (other shapes can be formed). An opening 116 can be formed in the housing 106 that extends from the housing top 108 to the housing bottom 110. The opening 116 can allow fluid to flow through the housing 106, entering in through the housing top 108 and exiting the housing bottom 110. In some embodiments, the housing top 108 can have a bevel 109 so as to funnel fluid into the opening 116.

The housing bottom 110 can have a pin and spring assembly 118 disposed therein. For example, the housing bottom 110 can have a housing flat 120 that extends from the housing sides 112 and into the housing center. The housing flat 120 can have at least one housing flat aperture 121 formed therein to allow fluid to flow there-through. A center portion of the housing flat 120 (corresponding with a center of the housing 106) can be configured to support and retain the pin and spring assembly 118. For example, the center portion of the housing flat 120 can have a pin aperture 124 configured to slidably receive the pin 122 of the pin and spring assembly 118. The spring 140 of the pin and spring assembly 118 can be configured to rest upon a portion of the housing flat 120 that surrounds the pin aperture 124. Some embodiments of the housing flat 120 can include a riser 126 that is located adjacent the pin aperture 124. The riser 126 can be at least one element extending upwards toward the housing top 108. The element can be a bar, a protrusion, a prong, an annular formation, or some other formation. The riser 126 can be used to support the pin and spring assembly 118 in an up-right position (e.g., so that the pin and spring assembly 118 is oriented to be aligned with the housing longitudinal axis 114). The riser 126 can also be used to secure the spring 140 so as to prevent it from sliding in a direction perpendicular to the housing longitudinal axis 114.

The pin 122 has a pin first end 128 and a pin second end 130. The pin first end 128 can extend through the pin aperture 124 and below the housing bottom 110. The pin second end 130 extends through the pin aperture 124 and remains within the opening 116.

As the pin 122 is caused to slide along the housing longitudinal axis 114, the pin 122 traverses the pin aperture 124. The pin second end 130 includes a pin head 132. The pin head 132 can be configured to secure a magnet 134 thereon or thereto. The magnet 134 can be a disc shaped element having a diameter that is at least as large as a diameter defined by the riser 126. This allows the magnet 134 to come into contact with the riser 126 when the pin 122 is caused to move towards the housing bottom 110. It should be noted that other shapes of the magnet 134 can be used. These can include a crescent shape, square shape, cam shape, circular shape, oval shape, etc.

The pin and spring assembly 118 is configured to allow the pin 122 to move along the housing longitudinal axis 114 in a first direction 136 (a direction towards the housing top 108) and in a second direction 138 (a direction away from the housing top 108). In some embodiments, he resting length of the spring 140 is such that the magnet 134 does not come into contact with the housing top 108 or does not allow the magnet 134 to extend through the housing top 108. In some embodiments, the resting length of the spring 140 is such that the magnet 134 does come into contact with the housing top 108 or does allow the magnet 134 to extend through the housing top 108. The riser 126 can act as a mechanical stop by abutting against the magnet 134 when the pin 122 is caused to move in the second direction 138.

It is contemplated for the device 100 to be placed within a conduit 102 that is configured to provide fluid communication between parts of a fluid flow system. The conduit 102 may be a portion of the fluid flow system designated for receiving and directing fluid when a leak occurs. In some embodiments, the conduit 102 can be connected to or attached to an overflow outlet. In some embodiments, the overflow outlet can be part of the backflow preventer 156. The device 100 may be placed within the conduit 102 to be used for detecting the leak. When a leak occurs, fluid will begin to flow in the conduit 102. Because the device 100 is placed within the conduit 102, the fluid will flow into the device 100 through the housing top 108. The fluid will impart a force on the magnet 134, which will be translated to the pin and spring assembly 118 and cause the pin and spring assembly 118 to compress. The compression of the pin and spring assembly 118 will allow the magnet 134 to move in the second direction 138. The compression of the pin and spring assembly 118 will be a function of the fluid flow. Thus, the greater the fluid flow, the greater the compression. The fluid flow can be variable. Thus, as the fluid flow changes, the compression of the pin and spring assembly 118 changes accordingly. This change in compression causes the magnet 134 to move in the first and second directions 136, 138, accordingly. The movement can be defined by a distance from the point at which the magnet 134 is located due to the resting length of the spring 140. The movement will be a function of the fluid flow rate and/or the fluid pressure. For example, fluid flow at a first flow rate (e.g., a low flow rate—or a small leak) can cause the magnet 134 to move in the second direction 138 by an amount D₁. Fluid flow at a second flow rate (e.g., a high flow rate—or a large leak) can cause the magnet 134 to move in the second direction 138 by an amount D₂. D₂ is greater than D₁. A third flow rate can be a variable flow rate, wherein the magnet 134 is caused to move to various distances.

In some embodiments, the pin and spring assembly 118 can be configured to only move when a predetermined amount of flow is generated. For example, the compressive strength of the spring 140 can be selected so that the spring 140 does not begin to compress until there is a threshold fluid flow rate. Before that threshold fluid flow rate occurs, any fluid will merely flow off the magnet 134 (without causing it to move), and flow out from the device 100 by exiting the housing bottom 110. But when the threshold fluid flow rate is met, the force of the fluid flow will cause the spring 140 to compress, thereby causing the magnet 134 to move.

Some embodiments of the device 100 can include at least one reed switch 142. The reed switch 142 can be attached to a portion of the housing 106 and/or the conduit 102. As the pin and spring assembly 118 compresses, the magnet 134 moves in the direction of the compression. As the magnet 134 moves in the direction of the compression, the magnet 134 moves to be more proximate to the reed switch 142 and causes the reed switch 142 to close an electrical circuit, thereby generating a signal. The signal can be transmitted to a processor for storing and analyzing. The signal can be used to identify that a leak has occurred. For example, the signal can be used to generate an alarm, an alert, or some other notification. In addition, or in the alternative, the signal can be used to perform data analysis. For example, the processor can use the signal to perform statistical and other numerical method analyses, generate graphs, generate real-time displays, etc.

While embodiments may describe and illustrate the reed switch 142 in a vertical orientation (e.g., parallel with the longitudinal axis 114), other orientations can be used. For example, the reed switch 124 can have a vertical orientation, horizontal orientation, diagonal orientation, etc.

Some embodiments can include a plurality of reed switches 142. For example, a first reed switch 142 can be positioned at D₁, a second reed switch 142 can be positioned at D₂, etc. As the fluid causes the magnet 134 to move along the housing longitudinal axis 114, the magnet 134 can become proximate to the first reed switch 142 and/or the second reed switch 142. When the first reed switch 142 generates a signal, that can be an indication that the magnet 134 moved by distanced D₁. When the second reed switch 142 generates a signal, that can be an indication that the magnet 134 moved by distanced D₂.

In some embodiments, pin and spring assembly 118 can be configured such that the magnet 134 moves out of proximity with the first reed switch 142 when it moves in proximity with the second reed switch 142, and the magnet 134 moves out of proximity with the second reed switch 142 when it moves in proximity with the first reed switch 142. The same can be true for other reed switches, if more than two are used. Thus, only one signal is generated, which would be from either the first reed switch 142 or the second reed switch 142. In some embodiments, pin and spring assembly 118 can be configured such that the magnet 134 stays in proximity with the first reed switch 142 when it moves in proximity with the second reed switch 142, and the magnet 134 stays in proximity with the second reed switch 142 when it moves in proximity with the first reed switch 142, but moves out of proximity from both reed switches 142 only when there is no fluid flow. Thus, two signals are generated, which would be from the first reed switch 142 and the second reed switch 142. In embodiments with more than two reed switches, the pin and spring assembly 118 can be configured to operate in this way for any number of reed switches 142 within the plurality of reed switches 142.

Some embodiments can involve detecting discrete states of operation. This can include detecting a first operational state, a second operational state, a third operational state, etc. The first operational state can be a state in which no fluid is being imparted on the magnet 134. In the first operational state, the magnet 134 can be positioned at Dₒ (meaning the magnet 134 is not moved from the distance at which the resting length sets the magnet 134). This would be indicative of no flow of fluid through the conduit 102, or no leak in the system. The second operational state can be a state in which a first volume of fluid or first flow of fluid is imparted on the magnet 134, causing the magnet 134 to move to D₁. This can be indicative of a first flow rate (e.g., a low flow rate—or a small leak). In some embodiments, this can be indicative of an acceptable operation or a faulty operation, depending on the threshold of the system. The third operational state can be a state in which a second volume of fluid or second flow of fluid is imparted on the magnet 134, causing the magnet 134 to move to D₂. This can be indicative of a second flow rate (e.g., a high flow rate—or a large leak). In some embodiments, this can be indicative of a faulty operation or a faulty operation in which immediate action is required, depending on the threshold of the system.

As noted herein embodiments can include a processor. In at least one embodiment, the processor can be configured to monitor the connectivity of the reed switch(es) 142. For example, the signal generated by any of the reed switches 142 may not be processed (i.e., the device 100 may not detect a leak) unless the processor obtains a signal from the reed switch 142. The processor can be configured to request, or otherwise search for, a signal from the reed switch 142. This can be done continuously, periodically, at random, or by some other scheme. This can allow a user to tailor the sensitivity and energy usage of the device 100. For instance, the device 100 can be set to high sensitivity by causing the processor to monitor the reed switch 142 continually. The device 100 can be set to a lower sensitivity by causing the processor to monitor the reed switch 142 periodically. This may be done to reduce power and computational consumption, and thus generate added efficiencies in the device 100.

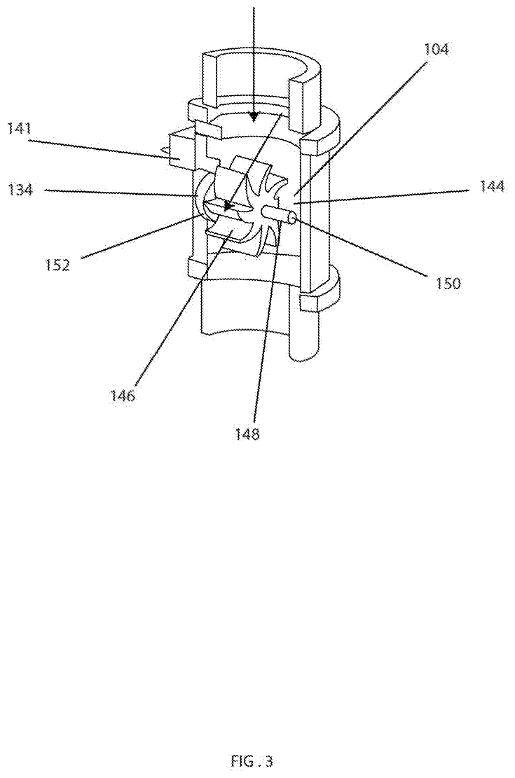

As shown in FIG. 3, other types of movable magnet elements 104 can be used. For example, a magnet-pinwheel assembly 144 can be used instead of the pin and spring assembly 118. The interior of the housing sides 112 can be configured to rotatingly receive a pinwheel 146. The pinwheel 146 can be secured via a pinwheel pin 148 having a pinwheel pin first end 150 and a pinwheel pin second end 152. The pinwheel pin first end 150 can be rotatingly attached to the housing side 112. The pinwheel pin second end 152 can include the magnet 134. The device 100 can include an electrical conductor element 141 located proximate to the pinwheel pin second end 152. As fluid flows, it will impart a force on the pinwheel 146, causing it to rotate. The rotation of the pinwheel 146 will cause the magnet 134 to rotate. The rotation of the magnet 134 can produce the Hall

Effect in the nearby electrical conductor element 141 (or plurality of electrical conductor elements 141). Thus, no signal is generated when the magnet 134 is stationary, but a signal is generated when the magnet 134 rotates. The rotation of the pinwheel 146, and thus the magnet 134, is a function of the fluid flow. The greater the fluid flow (the lager the leak), the faster the pinwheel 146 (and magnet 134) will rotate. Thus, the signal generated by the electrical conductor elements 141 can be a function of the rotational rate of the magnet 134.

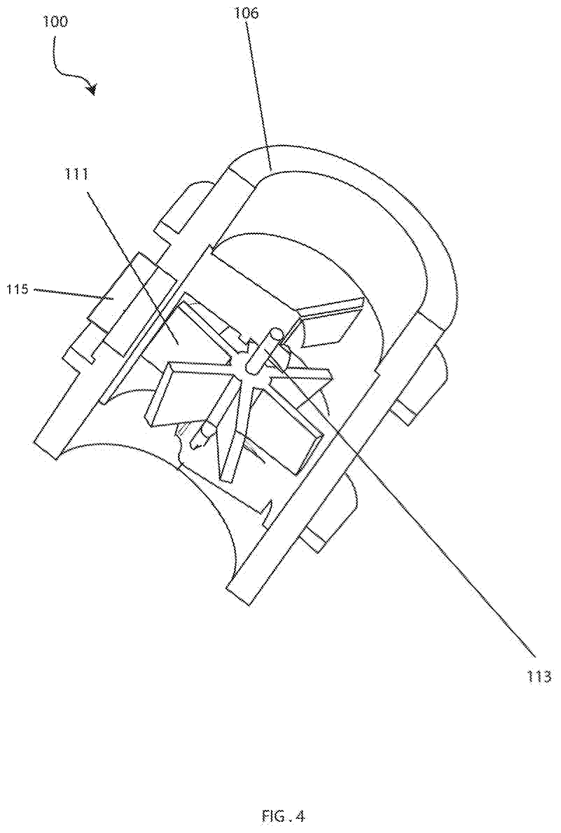

FIG. 4 shows another embodiment of a leak detection device 100. A turbine 111 can be positioned within the housing 106 such that the interior of the housing sides 112 rotatingly receive the turbine 111. The turbine blades can be oriented such that flow through the housing 106 will cause the turbine 111 to rotate. The turbine 111 can be connected to a shaft 113. As the turbine 111 rotates, the shaft 113 rotates. The shaft 113 can be in connection with an encoder 115. The encoder 115 can be a processor, a circuit, a transducer, etc. configured to convert rotational motion to a signal. For example, the greater the rotation the greater the magnitude of the signal, the frequency of the signal, etc.

The lower the rotation the lower the magnitude of the signal, the frequency of the signal, etc. The flow rate of the fluid through the turbine 111 is proportional to the rotational rate of the turbine 111 (and in turn the shaft 113). Thus, sticking with the example above, the greater the flow rate the greater the amplitude or frequency of the signal, and the lower the flow rate the lower the amplitude or frequency of the signal. In some embodiments, the encoder 115 can be a magnet 134 attached to the shaft 113 and an electrical conductor element 141 attached to the housing 106. Alternatively, the magnet 134 can be attached to the housing 106 and the electrical conductor element 141 attached to the shaft 113. In either case, as the shaft 113 rotates a signal can be generated by the electrical conductor element 141. A processor or some other computational device can be used to generate data that is representative of the rotational rate of the turbine 111.

Again, embodiments can include a processor configured to monitor the signal generated by the electrical conductor elements 141. For example, the signal generated by the electrical conductor elements 141 may not be processed (i.e., the device 100 may not detect a leak) unless the processor obtains a signal from the electrical conductor elements 141. The processor can be configured to request, or otherwise search for, a signal from the electrical conductor elements 141. This can be done continuously, periodically, at random, or by some other scheme. This can allow a user to tailor the sensitivity and energy usage of the device 100. For instance, the device 100 can be set to high sensitivity by causing the processor to monitor the electrical conductor elements 141 continually. The device 100 can be set to a lower sensitivity by causing the processor to monitor the electrical conductor elements 141 periodically. This may be done to reduce power and computational consumption, and thus generate added efficiencies in the device 100.

In addition, the processor can be configured to differentially detect a discrete state of operation for the magnet-pinwheel assembly 144 embodiment. For example, the processor can be programmed with at least one threshold value, each threshold value corresponding to a signal (where the signal is a function of the rotational rate of the magnet 134, and thus the amount of fluid flow). This can include detecting a first operational state, a second operational state, a third operational state, etc. The first operational state can be a state in which no fluid is being imparted on the pinwheel 146. The pinwheel 146 would not rotate in this situation. This would be indicative of no flow of fluid through the conduit 102, or no leak in the system. The second operational state can be a state in which a first volume of fluid or first flow of fluid is imparted on the pinwheel 146, causing the pinwheel 146 to rotate at a rate of R₁. This can be indicative of a first flow rate (e.g., a low flow rate—or a small leak). In some embodiments, this can be indicative of an acceptable operation or a faulty operation, depending on the threshold of the system. The third operational state can be a state in which a second volume of fluid or second flow of fluid is imparted on the pinwheel 146, causing the pinwheel 146 to rotate at a rate of R₂. This can be indicative of a second flow rate (e.g., a high flow rate—or a large leak). In some embodiments, this can be indicative of a faulty operation or a faulty operation in which immediate action is required, depending on the threshold of the system.

In some embodiments, the reed switch 142 can be connected to a power supply 154. The power supply 154 can be an electrical outlet, a battery, or an energy harvester unit. In some embodiments, the device 100 can be configured such that the reed switch(es) 142 generates a signal only when a leak is detected. This can be done to reduce power consumption.

It is contemplated for the conduit 102 to be a portion of a backflow preventer 156 and/or an overflow outlet. Thus, the device 100 can be placed within or on a portion of a backflow preventer 156 and/or within or on a portion of an overflow outlet. Embodiments of the backflow preventer 156 can be configured as a device that allows fluid to flow in a first direction but prevents fluid from flowing in a second direction. The backflow preventer 156 has a housing configured to make a fluid connection between a first pipe 158 and a second pipe 160. The housing can have an arrangement of valves and other components to facilitate fluid flow in a first direction but to prevent fluid flow in a second direction. The first direction can be from the first pipe 158 to the second pipe 160. The second direction can be from the second pipe 160 to the first pipe 158. Types of backflow preventers 156 that may be used can be, but are not limited to, an air gap preventer unit, an atmospheric vacuum breaker preventer unit, a single or double check valve preventer unit, a chemigation valve preventer unit, a pressure vacuum breaker preventer unit, a reduced pressure principle preventer unit, and a spill resistant pressure vacuum breaker preventer unit, etc.

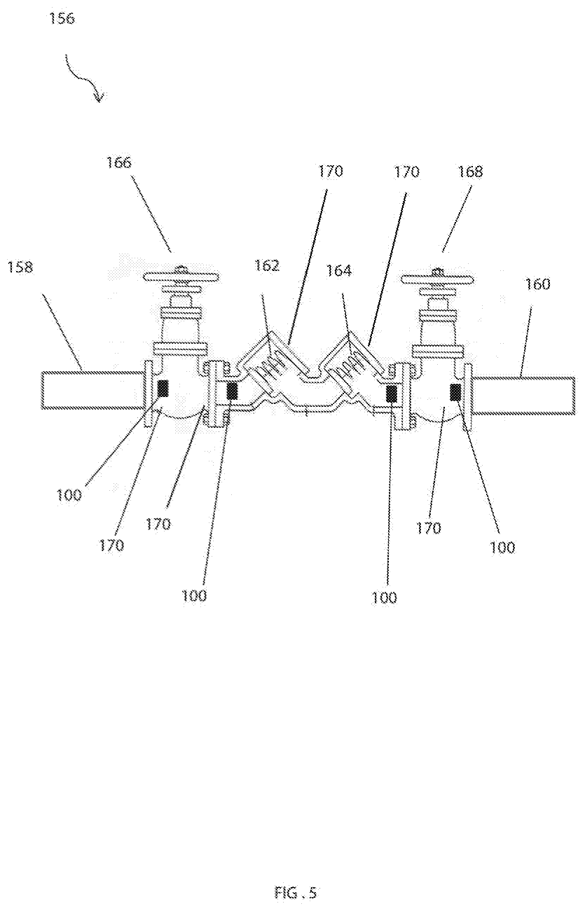

FIG. 5 shows an exemplary backflow preventer 156 that may be used. In the exemplary embodiment shown in FIG. 5, the backflow preventer 156 has a housing with a first check valve 162, a second check valve 164, a first shut off valve 166, a second shut off valve 168, and at least one test cock 170. The first pipe 158 is connected to the backflow preventer 156 at the first shut off valve 166. The second pipe 160 is connected to the backflow preventer 156 at the second shut off valve 168. When the first and second shut off valves 166, 168 are open, fluid can flow from the first pipe 158, through the first and second check valves 162, 164, and to the second pipe 160. However, fluid cannot flow from the second pipe 160 to the first pipe 158. This unidirectional fluid flow is due to the configuration and orientation of the first and second check valves 162, 164. The backflow preventer 156 shown in FIG. 2 is one of many examples of how a backflow preventer 156 can be configured.

It may be desirous to determine if fluid is flowing from the second pipe 160 to the first pipe 158 (e.g., faulty or degraded operation of the backflow preventer 156 or system instability). Thus, at least one device 100 can be placed in the backflow preventer 156 so that the housing top 108 is more proximate to the second shut off valve 168 and the housing bottom 110 is more proximate the first shut off valve 166. Thus, when fluid flows from the first pipe 158 to the second pipe 160 (the desired flow direction), the device 100 does not generate a signal. When fluid flows from the second pipe 160 to the first pipe 158 (the undesired flow direction), the device 100 generates a signal.

It should be understood that modifications to the embodiments disclosed herein can be made to meet a particular set of design criteria. For instance, the number of or configuration of pin and spring assemblies 118, magnet-pinwheel assemblies 144, backflow preventers 156, and/or other components or parameters may be used to meet a particular objective. In addition, any of the embodiments of the device 100 disclosed herein can be connected to other embodiments of the device 100 to generate a desired device 100 configuration.

It will be apparent to those skilled in the art that numerous modifications and variations of the described examples and embodiments are possible in light of the above teachings of the disclosure. The disclosed examples and embodiments are presented for purposes of illustration only. Other alternative embodiments may include some or all of the features of the various embodiments disclosed herein. For instance, it is contemplated that a particular feature described, either individually or as part of an embodiment, can be combined with other individually described features, or parts of other embodiments. The elements and acts of the various embodiments described herein can therefore be combined to provide further embodiments.

Therefore, it is the intent to cover all such modifications and alternative embodiments as may come within the true scope of this invention, which is to be given the full breadth thereof. Additionally, the disclosure of a range of values is a disclosure of every numerical value within that range, including the end points. Thus, while certain exemplary embodiments of apparatuses and methods of making and using the same have been discussed and illustrated herein, it is to be distinctly understood that the invention is not limited thereto but may be otherwise variously embodied and practiced within the scope of the following claims.

It should also be appreciated that some components, features, and/or configurations may be described in connection with only one particular embodiment, but these same components, features, and/or configurations can be applied or used with many other embodiments and should be considered applicable to the other embodiments, unless stated otherwise or unless such a component, feature, and/or configuration is technically impossible to use with the other embodiment. Thus, the components, features, and/or configurations of the various embodiments can be combined together in any manner and such combinations are expressly contemplated and disclosed by this statement. Thus, while certain exemplary embodiments of the device 100 have been shown and described above, it is to be distinctly understood that the invention is not limited thereto but may be otherwise variously embodied and practiced within the scope of the following claims.

What is claimed is:

1. A fluid flow indicator device, comprising:
a movable magnetic element configured to be placed within a conduit, the conduit configured to be a portion of a fluid flow system designated for receiving and directing fluid when a leak occurs; and
at least one reed switch;
wherein the movable magnetic element is configured to move relative to the at least one reed switch when fluid flows through the conduit due to the leak and imparts a force on the movable magnetic element; and
wherein the at least one reed switch generates a signal when the movable magnetic element is moved within a predetermined distance of the at least one reed switch.

2. The fluid flow indicator device recited in claim 1, wherein the at least one reed switch comprises a plurality of reed switches.

3. The fluid flow indicator device recited in claim 1, wherein the movable magnetic element comprises a pin and spring assembly.

4. The fluid flow indicator device recited in claim 1, further comprising a processor configured to monitor the connectivity of the at least one reed switch.

5. The fluid flow indicator device recited in claim 1, wherein the conduit is a portion of a backflow preventer or a portion of an overflow outlet.

6. The fluid flow indicator device recited in claim 1, wherein:
the at least one reed switch comprises a first reed switch and a second reed switch;
the first reed switch generates a first signal when the movable magnetic element moves a distance D₁;
the second reed switch generates a second signal when the movable magnetic element moves a distance D₂; and
D₂>D₁.

7. A fluid flow indicator device, comprising:
a housing comprising a housing top, a housing bottom, and a housing longitudinal axis extending from the housing top to the housing bottom, the housing further comprising an opening configured to allow fluid to flow there-through;
a movable magnetic element, the housing further configured to retain the movable magnetic element and allow the movable magnetic element to move along the housing longitudinal axis;
a first reed switch and a second reed switch;
wherein the movable magnetic element is configured to move relative to the first reed switch and the second reed switch when fluid flows through the housing;
wherein the first reed switch generates a first signal when the movable magnetic element moves a distance D₁;
the second reed switch generates a second signal when the movable magnetic element moves a distance D₂; and
D₂>D₁.

8. The fluid flow indicator device recited in claim 7, wherein the housing is configured to be placed within a conduit configured to be a portion of a fluid flow system designated for receiving and directing fluid when a leak occurs.

9. The fluid flow indicator device recited in claim 7, wherein the at least one of the first reed switch and the second reed switch is attached to the housing or the conduit.

10. The fluid flow indicator device recited in claim 7, further comprising a processor configured to monitor the connectivity of the first reed switch and the second reed switch.

11. The fluid flow indicator device recited in claim 7, wherein the movable magnetic element comprises a pin and spring assembly.

12. The fluid flow indicator device recited in claim 7, wherein the processor is configured to request or search for a signal from the first reed switch and/or the second reed switch periodically.

13. The fluid flow indicator device recited in claim 8, wherein the conduit is a portion of a backflow preventer or a portion of an overflow outlet.

14. The fluid flow indicator device recited in claim 7, wherein the processor is configured to request or search for a signal from the first reed switch and/or the second reed switch continuously.

15. The fluid flow indicator device recited in claim 7, wherein the housing top comprises a bevel configured to funnel the fluid.

16. The fluid flow indicator device recited in claim 7, wherein the housing bottom comprises housing flat and a riser.

17. The fluid flow indicator device recited in claim 16, wherein the housing flat comprises at least one housing flat aperture.

18. The fluid flow indicator device recited in claim 7, wherein the movable magnetic element comprises a pin and spring assembly and the housing bottom comprises a riser, the riser configured for at least one of:
support the pin and spring assembly so that the pin and spring assembly is oriented to be aligned with the housing longitudinal axis;
secure a spring of the pin and spring assembly so as to prevent the spring from sliding in a direction perpendicular to the housing longitudinal axis; and
act as a mechanical stop for the movable magnetic element.

19. The fluid flow indicator device recited in claim 11, wherein the pin and spring assembly comprises a pin having a magnet attached to a portion thereof, the pin configured to engage the spring so that the magnet moves in the housing longitudinal direction.

20. The fluid flow indicator device recited in claim 19, wherein a resting length of the spring is such that the magnet does not come into contact with the housing top or does not allow the magnet to extend through the housing top.

21. A fluid flow indicator device, comprising:
a movable magnetic element configured to be placed within a conduit, the conduit configured to be a portion of a fluid flow system designated for receiving and directing fluid when a leak occurs; and
at least one electrical conducting element;
wherein the movable magnetic element is configured to move relative to the at least one electrical conducting element when fluid flows through the conduit due to the leak and imparts a force on the movable magnetic element; and
wherein the at least one electrical conducting element generates a signal when the movable magnetic element is moved relative to the at least one electrical conducting element.

22. The fluid flow indicator device recited in claim 21, wherein the movable magnetic element comprises a magnet pinwheel assembly.

23. The fluid flow indicator device recited in claim 21, further comprising a processor configured to monitor the connectivity of the at least one electrical conducting element.
